(19) United States
(12) Patent Application Publication
(10) Pub. No.: US 2021/0116542 A1
(43) Pub. Date: Apr. 22, 2021

(54) DISTANCE MEASUREMENT SENSOR, CONTROL DEVICE, CONTROL METHOD AND NON-TRANSITORY COMPUTER-READABLE MEDIUM WITH PROGRAM STORED THEREIN

(71) Applicant: NEC Corporation, Tokyo (JP)

(72) Inventor: Akira TSUJI, Tokyo (JP)

(73) Assignee: NEC Corporation, Tokyo (JP)

(21) Appl. No.: 17/041,114

(22) PCT Filed: Mar. 28, 2018
(86) PCT No.: PCT/JP2018/012615

§ 371 Date: Sep. 24, 2020

(51) Int. Cl. G01S 7/484; G01S 17/89; G01S 17/10

(52) U.S. Cl. CPC G01S 7/484; G01S 17/10; G01S 17/89

(57) ABSTRACT

There are provided a control device for a distance measurement sensor, a control method for a distance measurement sensor, a distance measurement sensor, and a non-transitory computer-readable medium stored with a program, which can be used in a low-class safety standard. A control device (300) includes a management unit (2) for managing an emission-impossible direction of laser light in accordance with the output power of laser light swept by a distance measurement sensor per predetermined angle range, a scheduler (3) for scheduling emission of laser light based on the emission-impossible direction, and an emission instruction unit (4) for instructing the emission direction of the laser light according to the schedule.

### CROSS-REFERENCE TO RELATED PATENT APPLICATIONS

This application is a National Stage Entry of International Application No. PCT/JP2018/012615, filed Mar. 28, 2018. The entire contents of the above-referenced application are expressly incorporated herein by reference.

### TECHNICAL FIELD

The present disclosure relates to a distance measurement sensor, a control device, a control method, and a non-transitory computer-readable medium with a program stored therein.

### BACKGROUND ART

Patent Literature 1 discloses an object detection device using a lidar. The object detection device of Patent Literature 1 includes a light projection system for projecting pulsed laser light, and a light reception system for receiving reflected light from an object. The object detection device determines the distance to the object by measuring the time from an emission timing of pulsed light till a reception timing of the light.

When the distance to the object is less than a predetermined distance, the object detection device of Patent Literature 1 shifts from a non-attention mode to an attention mode. In the non-attention mode, when an object is present in a light projection range, the object detection device sets an area where the object is present as a region of interest. The object detection device repeats light projection to an attention area until the signal level of a light reception signal exceeds a threshold value.

### CITATION LIST

### Patent Literature

Patent Literature 1: Japanese Unexamined Patent Application Publication No. 2017-173298

### SUMMARY OF INVENTION

### Technical Problem

In the technique according to Patent Literature 1, laser light is used. For laser equipment, safety standards are defined by IEC (International Electrotechnical Commission) or JIS (Japanese Industrial Standards), or the like. According to the safety standard, a higher laser class is assigned to a device having a higher laser output. Even if the laser class 1 is shifted to the laser class 2, it does not immediately mean danger, but a safety countermeasure such as attaching a warning label is taken according to the laser class. The lower the laser class, the simpler the safety countermeasure. Therefore, it is desired to use a laser device having a lower safety standard.

An object of the present disclosure is to solve such a problem, and provide a distance measurement sensor, a control device, a control method, and a program that can be used with a low safety standard.

### Solution of Problem

A control device for a distance measurement sensor according to the present disclosure, comprises: a first management unit configured to manage an emission-impossible direction of laser light according to output power per predetermined angular range of laser light to be swept by the distance measurement sensor; a scheduler configured to schedule emission of the laser light based on the emission-impossible direction; and an emission instruction unit configured to instruct an emission direction of the laser light according to the schedule.

A distance measurement sensor according to the present disclosure comprises: an optical signal generation unit configured to generate an optical signal that is laser light; a direction control unit configured to sweep the laser light so as to change an emission direction of the laser light; a detector configured to detect reflected light from an object irradiated with the laser light; a signal processing unit configured to process a detection signal from the detector to measure a distance to the object; a first management unit configured to manage an emission-impossible direction of laser light according to output power of the swept laser light per predetermined angular range, a scheduler configured to schedule emission of laser light based on the emission-impossible direction; and an emission instruction unit configured to instruct an emission direction to the direction control unit according to the schedule.

A control method for a distance measurement sensor according to the present disclosure comprises a step of managing an emission-impossible direction of laser light according to output power of laser light to be swept by the distance measuring sensor per predetermined angular range; a step of scheduling emission of laser light based on the emission-impossible direction; and a step of instructing an emission direction of the laser light according to the schedule.

A non-transitory computer-readable medium according to the present disclosure is configured to store a program for causing a computer to execute a control method for a distance measuring sensor that comprises: a step of managing an emission-impossible direction of laser light according to output power of laser light to be swept by the distance measuring sensor per predetermined angular range; a step of scheduling emission of laser light based on the emission-impossible direction; and a step of controlling an emission direction of the laser light according to the schedule.

### Advantageous Effect of Invention

According to the present disclosure, it is intended to provide a distance measurement sensor, a control device, a control method, and a program that can be used with a low safety standard.

### BRIEF DESCRIPTION OF DRAWINGS

FIG. 1 is a diagram showing an outline of a control device of a distance measurement sensor according to an example embodiment of the present disclosure.

FIG. 2 is a functional block diagram showing a configuration of the distance measurement sensor.

FIG. 3 is a diagram showing a sensing area in a high-resolution mode and a low-resolution mode.

FIG. 4 is a diagram showing the relationship between a sweeping range and output power of laser light.

FIG. 5 is a functional block diagram showing a configuration of a control device of a distance measurement sensor.

FIG. 6 is a flowchart showing a control method.

FIG. 7 is a flowchart showing a method of managing a sensing-impossible memory.

### DESCRIPTION OF EXAMPLE EMBODIMENTS

### Summary of Example Embodiment According to the Present Disclosure

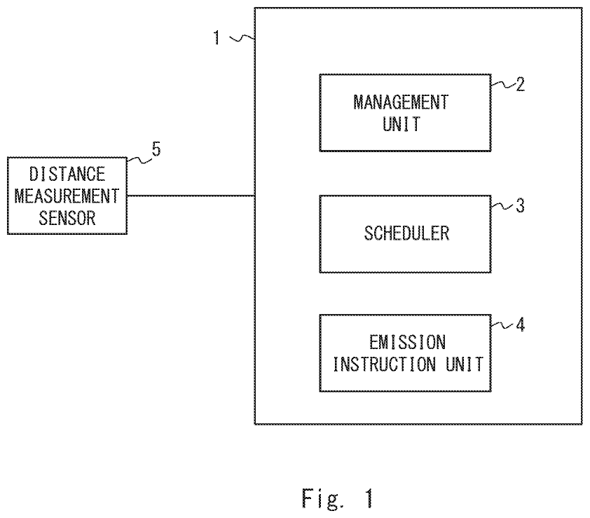

Prior to the description of an example embodiment according to the present disclosure, an outline of the example embodiment according to the present disclosure will be described. FIG. 1 is a diagram showing an outline of a control device 1 according to an example embodiment of the present disclosure.

The control device 1 includes a management unit 2, a scheduler 3, and an emission instruction unit 4. The management unit 2 manages an emission-impossible direction of laser light according to an output power per predetermined angular range of laser light to be swept by the distance measurement sensor 5. The scheduler 3 schedules the emission of laser light based on the emission-impossible direction. The emission instruction unit 4 indicates the emission direction of the laser light according to the schedule. This configuration enables the distance measurement sensor to be usable with a low safety standard.

Further, the distance measurement sensor 5 may include the control device 1 described above. The distance measurement sensor can be used with a low safety standard according to the control method to be executed by the control device. Further, the control method to be executed by the control device 1 can be implemented by a program to be executed by a computer.

### First Example Embodiment

The distance measurement sensor according to the present example embodiment measures a distance by using pulsed laser light. Specifically, the distance measurement sensor is a lidar (LIDAR: Light Detection and Ranging). The distance measurement sensor can recognize three-dimensional coordinates in a three-dimensional space. The three-dimensional space may be represented by a rectangular coordinate system or a polar coordinate system.

Use of the distance measurement sensor makes it possible to detect an intruding object or an intruder (hereinafter, the intruding object and the intruder are collectively referred to as an intruding object). Therefore, the distance measurement sensor can be used for monitoring private facilities, public facilities, etc. For example, it is possible to monitor target facilities as monitoring targets by arranging a plurality of distance measurement sensors in the target facilities to be monitored.

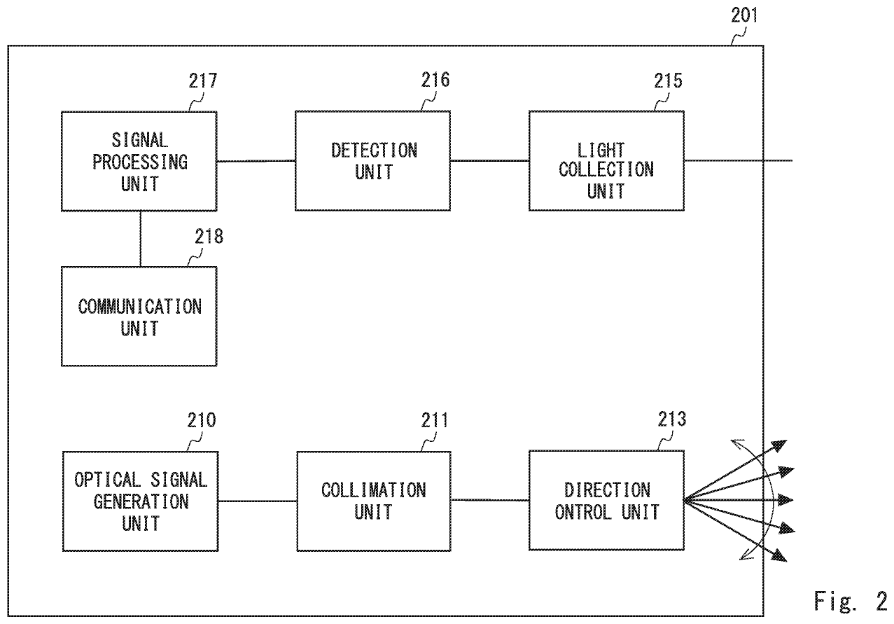

The configuration of the distance measurement sensor 201 will be described with reference to FIG. 2. FIG. 2 is a functional block diagram showing the distance measurement sensor 201. The distance measurement sensor 201 will be described as a lidar using pulsed laser light as a measurement signal. The distance measurement sensor 201 includes an optical signal generation unit 210, a collimation unit 211, a direction control unit 213, a light collection unit 215, a detection unit 216, a signal processing unit 217, and a communication unit 218.

The optical signal generation unit 210 includes a light source for generating an optical signal serving as a measurement signal. Specifically, the optical signal generation unit 210 has a laser diode or the like that generates pulsed laser light. The optical signal generation unit 210 generates pulsed laser light having a predetermined repetition frequency as a measurement signal. The optical signal generation unit 210 may be able to adjust the light intensity, the repetition frequency, etc. of the measurement signal.

The collimation unit 211 includes a lens and the like, and collimates pulsed laser light that is an optical signal. For example, the collimation unit 211 converts the pulsed laser light into a parallel light flux.

The direction control unit 213 controls the emission direction of the optical signal. For example, the direction control unit 213 has a scanner and an optical system, and sweeps the emission direction of the optical signal. The direction control unit 213 has a rotating mirror or the like, and sweeps the optical signal at a constant rotation speed. The rotation of the rotating mirror makes it possible to change the emission direction of the optical signal.

For example, a rotating mirror that can rotate by 360° is used as a scanner with a Z direction orthogonal to a horizontal plane (XY plane) set as a rotation axis, which enables the distance measurement sensor 201 to emit optical signals in all directions. Of course, the sweeping range is not limited to the entire circumference of 0 to 360°, but may be a partial range. In other words, the sweeping range may be set according to a direction to be monitored. Further, the sweeping range of the direction control unit 213 is made variable.

Furthermore, the direction control unit 213 may also sweep the pulsed laser light in an up-and-down direction. The direction control unit 213 can perform three-dimensional sweeping by changing both the azimuth angle and the elevation angle. Note that the azimuth angle is an angle within a horizontal plane centered on the distance measurement sensor 201 and having a reference azimuth (for example, the true north direction) as 0°. The elevation angle is an angle within a vertical plane where the horizontal direction is 0° and the vertically upward direction is 90°.

The optical signal swept by the direction control unit 213 is emitted from the distance measurement sensor 201. The direction in which the optical signal is emitted corresponds to the sweeping angle in the direction control unit 213, that is, the angle of the rotating mirror. If it is assumed that the repetition cycle of the pulsed laser light and the sweeping speed are constant, an optical signal is emitted at each constant azimuth angle. The optical signal is reflected by an object around the distance measurement sensor 201. The optical signal reflected by the object is used as reflected light. Since the optical signal is pulsed light, the reflected light is also pulsed light.

The light collection unit 215 has a lens and the like, and collects the reflected light reflected by the object. The detection unit 216 detects the reflected light collected by the light collection unit 215. The detection unit 216 has a photosensor such as a photodiode. The detection unit 216 outputs a detection signal corresponding to the detected light amount to the signal processing unit 217.

The signal processing unit 217 has a circuit and a processor that perform predetermined processing on the detection signal from the detection unit 216. The signal processing unit 217 calculates the distance to a target object based on the detection signal. The signal processing unit 217 estimates the time from the emission of the pulsed laser light as an optical signal until the detection by the detection unit 216. Then, the signal processing unit 217 measures the distance to the target object based on the estimated time. In other words, the signal processing unit 217 calculates the distance to the target object from the difference between a timing when the optical signal generation unit 210 generates pulsed laser light and a timing when the detection unit 216 detects the pulsed laser light. The signal processing unit 217 determines a turnaround time to a reflection position where the optical signal is reflected, and calculates the distance to the surface of the target object based on the turnaround time.

The distance to the target object around the distance measurement sensor 201 can be measured by performing the above operation. Further, since the direction control unit 213 controls the emission direction of the optical signal, it is possible to measure the distance to the target object in each azimuth. The direction control unit 213 repeatedly sweeps a predetermined sweeping range, so that measurement data is updated at any time.

The communication unit 218 transmits the measurement data to a control device described later by wired communication or wireless communication. Furthermore, the communication unit 218 may send an emission completion notification to the control device. The emission completion notification is a signal indicating an emission-completed direction and an emission time. The communication method of the communication unit 218 is not particularly limited. The communication unit 218 transmits the latest measurement data at regular intervals. For example, when the measurement of the whole or a part of the sweeping range (for example, 0 to 360°) is completed, the communication unit 218 transmits the newly acquired measurement data. Then, the distance measurement sensor 201 repeatedly sweeps the optical signal, whereby the measurement data is updated.

Note that the control device of the distance measurement sensor 201 may be a device different from the distance measurement sensor 201, or may be installed in the distance measurement sensor 201. In other words, the control device and the distance measurement sensor 201 may be physically a single device or separate devices. When the control device and the distance measurement sensor 201 are physically a single device, the communication unit 218 may be omitted.

As described above, the distance measurement sensor 201 detects intrusion of an intruding object. For example, when an intruding object enters a sensing range of the distance measurement sensor 201, the measurement distance indicated by the measurement data of the distance measurement sensor 201 is shortened. Therefore, the intrusion can be detected based on the sensing result of the distance measurement sensor 201.

The distance measurement sensor 201 narrows the sensing area and performs high-resolution measurement in order to identify an intruding object or an intruder. High-resolution measurement allows identification of the shape, etc. of the intruding object. The relationship between the sweeping range of the lidar and the resolution will be described below.

In the lidar, the sweeping range and the sensing density have inverse proportion relationship with each other. For example, the number of points N at which the distance measurement sensor senses per unit time is a fixed value defined by the repetition frequency of the pulsed laser light. In other words, the number N of points to be sensed per unit time is constant. By using the sweeping range per unit time and the sensing density, the number N of points to be sensed per unit time is shown as follows.

N=(sweeping range per unit time)×(sensing density)

The sweeping range per unit time is defined, for example, by the sweeping speed by the direction control unit 213, that is, the rotation speed of the rotating mirror. The sensing density is defined, for example, by the number of pulses to be irradiated per unit angle (unit solid angle in the case of three-dimensional sweeping). Assuming that the sweeping speed is constant, the points to be sensed are concentrated in a narrow range by narrowing the sweeping range. In other words, by narrowing the sweeping range, the points to be sensed can be made closer on the surface of the intruding object.

By narrowing the sensing area, the distance measurement sensor 201 can perform higher resolution sensing. For example, when the sweeping range of 360° per second is changed to the sweeping range of 10° per second, the sensing density, that is, the resolution is enhanced thirty-six times. By irradiating a range containing an intruding object with pulsed laser light at a high sensing density, the measurement can be performed with high resolution and the intruding object can be specified.

Before detecting the intrusion, the distance measurement sensor 201 is set to a low-resolution mode in which sweeping is performed in a wide sensing range. After detecting the intrusion, the distance measurement sensor 201 is set to a high-resolution mode in which sweeping is performed in a narrow sensing range.

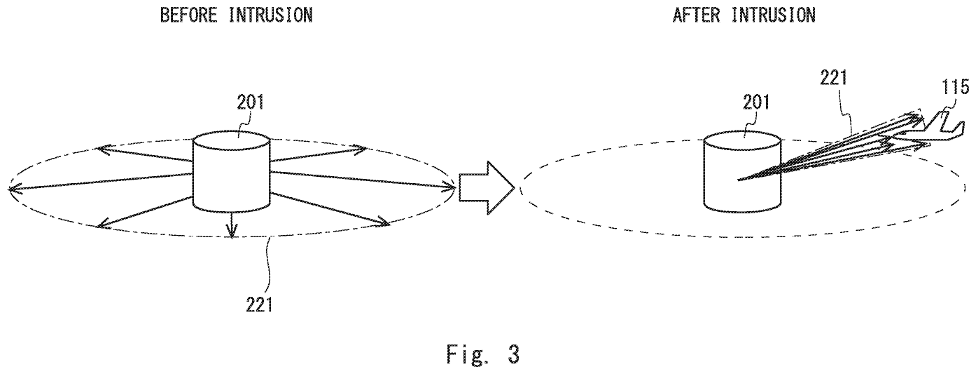

Identification of an intruding object by the distance measurement sensor 201 will be described with reference to FIG. 3. FIG. 3 is a diagram showing a change in the sensing area 221 before and after the intrusion of the intruding object 115. In FIG. 3, the sensing area 221 before the intrusion is shown on the left side, and the sensing area 221 after the intrusion is shown on the right side.

Before the intrusion of the intruding object 115, the distance measurement sensor 201 is set to the low-resolution mode. The distance measurement sensor 201 sweeps omnidirectionally. In other words, the distance measurement sensor 201 sweeps the laser light in a wide sweeping range, and the sensing area 221 has a circular shape.

When the intruding object 115 intrudes into the sensing area 221, the distance measurement sensor 201 is set to the high-resolution mode. The distance measurement sensor 201 narrows the sensing area 221 for the intruding object 115. For example, in the case of three-dimensional sweeping, the sensing area 221 is set to have a conical shape (cone shape) facing the intruding object 115. By increasing the sensing density for the intruding object 115, the distance measurement sensor 201 can perform high-resolution sensing.

As described above, when detecting the intruding object 115, the distance measurement sensor 201 narrows the sensing area to perform the sensing in the high-resolution mode. In other words, the distance measurement sensor 201 emits an optical signal to the intruding object 115 with a high sensing density. By performing high-resolution sensing, the distance measurement sensor 201 can detect the shape of the intruding object 115. It is possible to identify the intruding object 115 from the shape of the intruding object 115. On the other hand, when the intruding object has not been detected, the distance measurement sensor 201 widens the sweeping range and performs the measurement in the low-resolution mode.

Some lidars can perform long-distance sensing of 1 km or more. An example of use of such a lidar is to detect drones approaching facilities such as stations, airports, and shopping malls from a distance. Illegal trespass by drones is becoming a global problem, and in order to take countermeasures against such drones, a lidar capable of perform long-distance sensing of, for example, on the order of 1 km to 10 km is used as the distance measurement sensor 201.

It is preferable that such a lidar satisfies the safety standard of the laser class 1 (safety standard) because the installation place thereof may be near to an urban area in some cases. The laser class is determined on the assumption of a case where an eyeball or a skin is irradiated with laser light at a short distance of about 10 cm. As one of determination methods, the amount of energy of laser light to be irradiated in a diameter range of 7 mm at a distance of 10 cm for a certain period is determined, and compared with the safety standard defined for each class. For example, the laser class 1M is restricted so that the laser output power in a circular aperture having a diameter of 7 mm at a distance of 100 mm from a light source is not more than a predetermined value.

On the other hand, it is preferable that the output power of laser light is increased so that the reflected light of the laser light is not buried in noise. In particular, in order to perform long-distance sensing, it is desired to increase the output power of laser light.

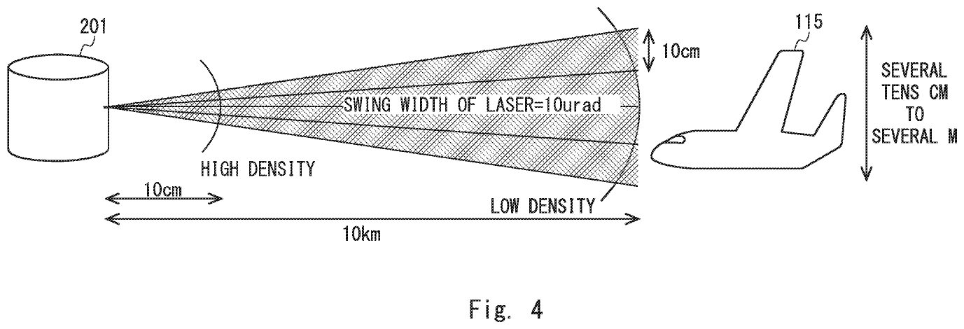

When the type of a drone is recognized for the purpose of detecting the drone, it is considered that the resolution should be at least 10 cm or less at a long distance of 10 km as shown in FIG. 4. In order to obtain a resolution of 10 cm at a distance of 10 km, the swing width (sweeping interval) of the laser light is required to be 10 prad (microradian). When sweeping is performed with a swing width of 10 prad, the frequency of emission of laser light (the number of pulses) included in a circular range of 7 mm at a distance of 10 cm is equal to 7,000 times. Therefore, when the high-resolution measurement is performed in a short time, the amount of energy determined according to the laser class may be exceeded.

Actually, when laser light is emitted to a circular range of 7 mm (70 mrad (milliradian)) at a distance of 10 cm, it corresponds to a circular range of 700 m at a distance of 10 km, so that the frequency of emission of laser light ranges from about several times to several tens times in the case of a circular range equivalent to the size of a drone (several tens cm to several m), and thus there is a possibility that the amount of energy determined according to the laser class will not be exceeded. However, it has not been known whether an intruding object is a drone at the time point when the intruding object is detected, and the intruding object can be identified by subsequent high-resolution sweeping. Since the intruding object may be a bird, a dust or the like as well as a drone, the number of intruding objects to be swept at high resolution is generally multiple. Therefore, as a result of performing high-resolution sweeping on all objects that have intruded into the circular range of 700 m, there is a possibility that the amount of energy determined according to the laser class is exceeded.

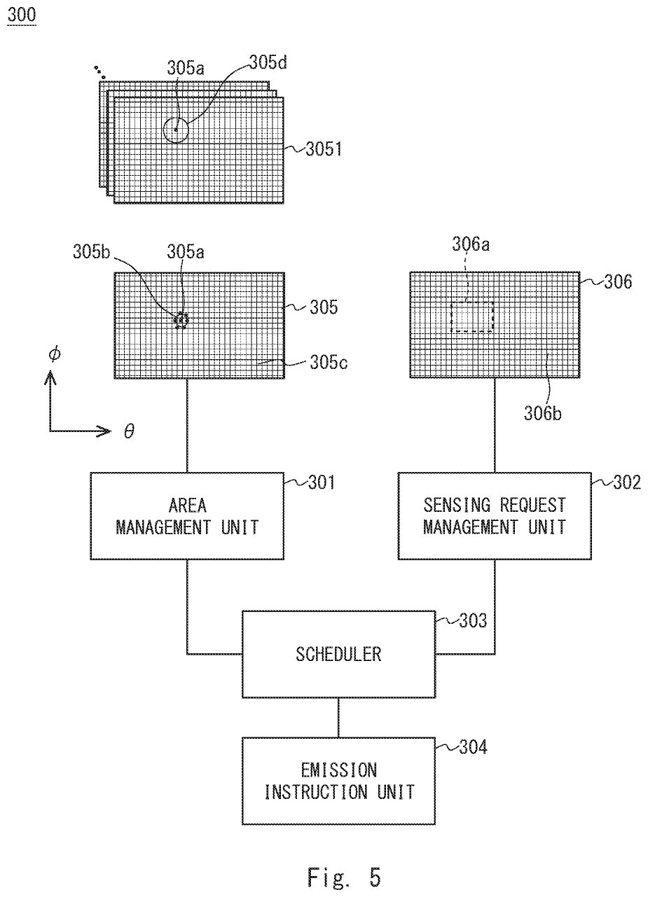

In other words, when pulsed laser light is continuously irradiated into a narrow area for a short time, there is a risk that the power of the laser may exceed the power defined by the laser safety standard. Even when the laser output power exceeds that of the laser class 1, it does not mean that the laser output power is immediately dangerous, but it is required to take an additional safety measure such as labeling. Therefore, in the present example embodiment, the control device manages the emission-impossible direction of laser light according to the output power of laser light to be emitted by the distance measurement sensor 201 per predetermined angular range. Hereinafter, the control device of the distance measurement sensor 201 according to the present example embodiment will be described with reference to FIG. 5. FIG. 5 is a functional block diagram showing a configuration of the control device 300.

The control device 300 includes an area management unit 301, a sensing request management unit 302, a scheduler 303, and an emission instruction unit 304. Note that the control device 300 may be, for example, a personal computer or a computer such as a server. The control device 300 is communicably connected to the distance measurement sensor 201 in a wired or wireless manner. For example, a wireless LAN such as Wi-Fi (registered trademark) may be used. Alternatively, the distance measurement sensor 201 may include the control device 300. In this case, for example, the control device 300 may be a processor or the like which is incorporated in the distance measurement sensor 201.

The area management unit 301 is a first management unit for managing the emission-impossible direction of laser light. The area management unit 301 has a memory for storing a sensing-impossible area that indicates the emission-impossible direction of laser light. Specifically, the area management unit 301 manages the emission-impossible direction by using a sensing-impossible area map 305.

For example, the sensing-impossible area map 305 is a map in which the emission direction of the laser light is two-dimensionally developed. The sensing-impossible area map 305 is two-dimensional map data in which the azimuth angle of the emission direction of the laser light is set to a horizontal direction (θ-axis) and the elevation angle thereof is set to a vertical direction (φ-axis). The θφ coordinate in the sensing-impossible area map 305 corresponds to the emission direction in which the laser light is emitted.

The area management unit 301 receives an emission completion notification from the scheduler 303 or the distance measurement sensor 201. The emission completion notification includes information on an emission-completed direction in which the laser light has been emitted and an emission time. Upon receiving the emission completion notification, the area management unit 301 creates the sensing-impossible area map 305. The sensing-impossible area map 305 is a map showing a sensing-impossible area 305b.

For example, the area management unit 301 records an emission-completed direction 305a together with an emission time for each pulse. A history of the emission-completed direction 305a is stored over the number of pulses which have been emitted within a set period. Whether emission of laser light is possible or impossible depends on the total energy amount of the laser light within a certain period of time. Therefore, the area management unit 301 calculates the total value (integral value) of the energy of the laser light during the set period. The area management unit 301 specifies, as the sensing-impossible area 305b, an area in which the total value (integral value) of energy exceeds a threshold value based on the safety standard. Specifically, the sensing-impossible area 305b is calculated according to the output power of the laser light per predetermined angle range.

For example, the area management unit 301 creates a candidate area map 3051 for each pulse. The candidate area map 3051 is a map indicating a candidate area 305d corresponding to one emission-completed direction 305a. An area within a predetermined distance from the emission-completed direction 305a is a candidate area 305d. The area management unit 301 adds a new candidate area map 3051 as an entry each time it receives an emission completion notification from the distance measurement sensor 201.

The area management unit 301 creates candidate area maps 3051 whose number corresponds to the number of pulses emitted within the set period. Therefore, the area management unit 301 stores a plurality of candidate area maps 3051 in the memory. The area management unit 301 creates the sensing-impossible area map 305 indicating the sensing-impossible area 305b by adding the plurality of candidate area maps 3051. For example, the area management unit 301 can calculate, as the sensing-impossible area 305b, an area in which the number of overlapping candidate areas 305d is large.

In this way, the area management unit 301 calculates the sensing-impossible area 305b based on the history of the emission-completed direction 305a. The area management unit 301 calculates the sensing-impossible area 305b so that the output power of the laser light per predetermined angular range does not exceed the threshold value defined by the safety standard. In other words, when pulsed laser light is continuously irradiated for a short time, a direction in which the laser output power exceeds that of the safety standard is specified, and set as the sensing-impossible area 305b. In the case of the laser class 1M, a direction in which the laser output power in a circular aperture of 7 mm in diameter at a distance of 100 mm from the light source is not less than a predetermined threshold value is set as the sensing-impossible area 305b. The sensing-impossible area 305b is determined from specification values such as the repetition frequency of the laser diode of the optical signal generation unit 210, the laser wavelength, and the output power per pulse.

In this way, the area management unit 301 manages the emission-impossible direction of laser light according to the output power per predetermined angular range of laser light to be swept by the distance measurement sensor 201. Further, the area management unit 301 also stores time information on the emission time in association with the emission-completed direction 305a. The time information may be a real time including hour, minute and second, or the like. When the repetition frequency of the measurement signal is constant, the time information may be a value indicating the number of pulses.

In the sensing-impossible area map 305, an area other than the sensing-impossible area 305b is a sensing-possible area 305c. The area management unit 301 creates the sensing-impossible area map 305 including the sensing-impossible area 305b, the sensing-possible area 305c, the emission-completed direction 305a, and the time information.

The area management unit 301 creates the sensing-impossible area map 305 from the history over the set period, and stores it in the memory. The area management unit 301 manages the history of the emission-completed direction 305a and the emission time and the like over the set period, that is, for the predetermined number of pulses. The area management unit 301 deletes a part of the history of the emission-completed direction 305a for which a set time or more has elapsed from the emission time. Note that the sensing-impossible area map 305 may have a data structure in which queues corresponding to the emission-completed directions 305a are collected.

Note that the area management unit 301 may update the sensing-impossible area map 305 for each pulse, or may update the sensing-impossible area map 305 for each predetermined time including a plurality of pulses. The area management unit 301 adds a new candidate area map 3051 and deletes an old candidate area map 3051 each time the data is updated.

The sensing request management unit 302 is a second management unit for managing a sensing request indicating a direction to be sensed. Here, the sensing request management unit 302 has a memory for storing a request bitmap 306. The request bitmap 306 is a map indicating whether there is a sensing request or not. The request bitmap 306 is a two-dimensional map in which the emission direction of laser light is developed as in the case of the sensing-impossible area map 305.

In other words, the request bitmap 306 is two-dimensional map data in which the azimuth angle is set to a horizontal direction (θ axis) and an elevation angle is set to a vertical depression angle (φ axis). The request bitmap 306 is a bitmap in which a sensing-requested direction is set to a first value (for example, 1), and a sensing-unrequested direction is set to a second value (for example, 0).

For example, when the distance measurement sensor 201 detects the intruding object 115 during sensing in the low-resolution mode, the control device 300 controls the distance measurement sensor 201 to shift to the high-resolution mode. In other words, the control device 300 narrows the sensing area 221 of the distance measurement sensor 201 so that the sensing area 221 contains the intruding object 115. When the intruding object intrudes into the sensing area of the distance measurement sensor 201, the control device 300 controls the distance measurement sensor 201 to perform sensing at higher density in the direction to the intruding object as compared with the low-resolution mode. As a result, a sensing request is made, and the request bitmap 306 is separated into a request area 306a and a non-request area 306b.

The request area 306a is an area containing a sensing-requested direction, and is set so that the sensing area 221 contains an intruding object 115. In other words, the request area 306a contains a direction to be sensed. The non-request area 306b is an area that does not contain any sensing-requested direction. In other words, the non-request area 306b contains directions in which sensing is not performed or directions in which sensing has been finished. The sensing request management unit 302 rewrites the bit of the request area 306a from 0 to 1 according to the sensing area 221.

The sensing request management unit 302 receives an emission completion notification from the distance measurement sensor 201 or the like. The sensing request management unit 302 updates the request bitmap 306 according to the emission completion notification. Upon receiving the emission completion notification, the sensing request management unit 302 rewrites the bit corresponding to the emission-completed direction 305a from 1 to 0.

In this way, the sensing request management unit 302 manages the request bitmap 306. Further, the sensing request management unit 302 may manage the priority of the sensing request. In other words, the single request area 306a may be divided into plural areas to give priorities to the plural areas, and sensing may be performed from an area having a higher priority. Since it is possible that plural areas to be sensed with high resolution occur simultaneously, plural request areas 306a may be set. Further, it is also possible to give priorities to the plural set request areas 306a.

The scheduler 303 schedules the emission of laser light based on the history of the emission-completed direction and the emission time. Specifically, the scheduler 303 refers to the sensing-impossible area map 305 and the request bitmap 306 to determine the emission schedule of the measurement signal.

The scheduler 303 reads a sensing-requested direction from the request bitmap 306. The scheduler 303 refers to the sensing-impossible area map 305 and determines whether the sensing-requested direction is a direction to the sensing-impossible area 305b. The scheduler 303 registers, in the schedule, directions which are sensing-requested directions and are not directions to the sensing-impossible area 305b. The schedule may be defined, for example, in a queue format in which the emission directions are arranged in the emission order.

The scheduler 303 stores, in a standby buffer, directions which are sensing-requested directions and are directions to the sensing-impossible area. With respect to the directions stored in the standby buffer, a measurement signal is emitted after the set time has elapsed. As a result, the distance measurement sensor 201 can be controlled so as to satisfy the safety standard. The scheduler 303 refers to the sensing-impossible area map 305 and the request bitmap 306 to determine emission directions (Op coordinates) and an emission order thereof. Further, the emission order may be set based on the priority of the sensing request as described above.

The emission instruction unit 304 outputs an emission instruction to the distance measurement sensor 201 according to the schedule. The direction control unit 213 of the distance measurement sensor 201 controls the scanner to output a measurement signal in an emission direction indicated by the emission instruction. In other words, the distance measurement sensor 201 sweeps the measurement signal so that the measurement signal is output from the measurement sensor 201 in the emission order conforming to the schedule.

When the distance measurement sensor 201 has emitted the measurement signal, the distance measurement sensor 201 outputs an emission completion notification to the area management unit 301 and the sensing request management unit 302. As described above, the emission completion notification includes the emission-completed direction and the emission time. The area management unit 301 updates the sensing-impossible area map 305 based on the emission completion notification. The sensing request management unit 302 updates the request bitmap 306 based on the emission completion notification.

The foregoing operation enables the direction control unit 213 to sweep the measurement signal so as not to exceed the safety standard. A laser device of a lower class may be used as the distance measurement sensor 201. For example, the distance measurement sensor 201 can be handled as a laser device of laser class 1M. Therefore, the required safety measure can be loosened.

The area management unit 301 manages the history of the emission-completed direction and the emission time. The area management unit 301 calculates sensing-impossible areas containing emission-impossible directions from the history. As a result, the area management unit 301 can easily manage the emission-impossible directions.

The emission instruction unit 304 manages sensing requests indicating directions to be sensed. Scheduling can be easily performed by instructing the emission of laser light in the directions which are the sensing-requested directions and are not the emission-impossible directions as described above.

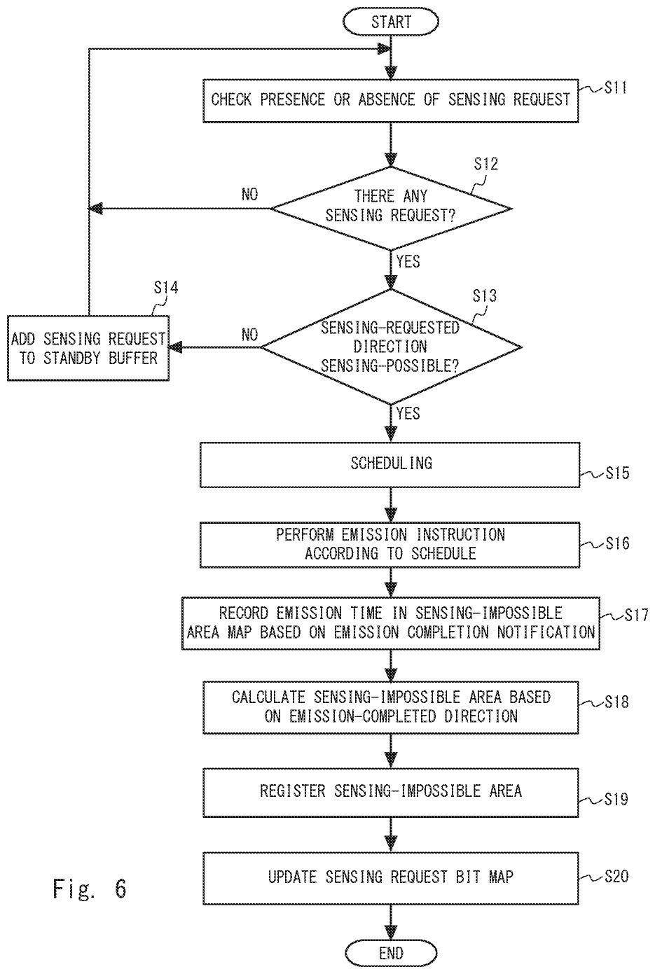

A control method according to the present example embodiment will be described with reference to FIG. 6. FIG. 6 is a flowchart showing a method of controlling the distance measurement sensor 201.

The scheduler 303 checks whether there is a sensing request (S11). Here, the scheduler 303 checks both the standby buffer and the request bitmap 306. The scheduler 303 refers to the request bitmap 306 to check whether there is a sensing request (S12). When there is no sensing request (NO in S12), the processing returns to S11. For example, when measurement signals have been emitted in all sensing-requested directions, the scheduler 303 determines that there is no sensing request. Alternatively, in the case of the low-resolution mode, an automatic sweeping mode in which sensing is performed according to a predetermined schedule may be set, and the scheduler 303 may determine that there is no sensing request for explicit control. The steps of S11 and S12 are repeated until it is determined that there is a sensing request.

When there is a sensing request (YES in S12), the scheduler 303 refers to the sensing-impossible area map 305 to determine whether a sensing-requested direction is sensing-possible (S13). When the sensing-requested direction is not sensing-possible (NO in S13), the scheduler 303 adds the sensing request to the standby buffer (S14). Then, the processing returns to S11 to repeat the processing. In S11, the scheduler 303 checks both the standby buffer and the request bitmap 306.

When the sensing-requested direction is sensing-possible (YES in S13), the scheduler 303 schedules the emission directions thereof (S15). For example, the scheduler 303 determines the emitting directions and the emission order thereof, and registers them in a queue. The emission instruction unit 304 performs an emission instruction according to the schedule (S16). In other words, the emission instruction unit 304 instructs the emission directions to the distance measurement sensor 201 in the scheduled emission order. As a result, the distance measurement sensor 201 emits the measurement signal in the scheduled order. In other words, the direction control unit 213 controls the sweeping angle based on the emission instruction.

Next, the area management unit 301 records the emission time in the sensing-impossible area map 305 based on the emission completion notification (S17). For example, the area management unit 301 adds a new sensing-impossible area map 305. The area management unit 301 calculates a sensing-impossible area 305b based on the emission-completed direction 305a (S18). The sensing-impossible area 305b is determined so as to satisfy the desired safety standard as described above. Therefore, an area around the emission-completed direction 305a becomes the sensing-impossible area 305b.

The area management unit 301 registers the sensing-impossible area 305b in the sensing-impossible area map 305 (S19). These processing enables the area management unit 301 to store the direction indicating the sensing-impossible area and the time information in association with each other in the memory. Further, the sensing request management unit 302 updates the request bitmap 306 (S20). In other words, the sensing request management unit 302 lowers the bit corresponding to the emission direction in the request bitmap 306.

By repeating the above processing, sensing is completed for all sensing-requested directions. As a result, the intruding object 115 can be sensed with high resolution, so that the distance measurement sensor 201 or the control device 300 can identify the intruding object 115. In other words, in the high-resolution mode, the swing angle (sweeping interval) of the laser light can be narrowed, so that the shape and size of the intruding object 115 can be specified. Further, even when the swing angle is narrowed, the operation can be performed so as to satisfy the laser safety standard. Therefore, the required safety measure can be loosened.

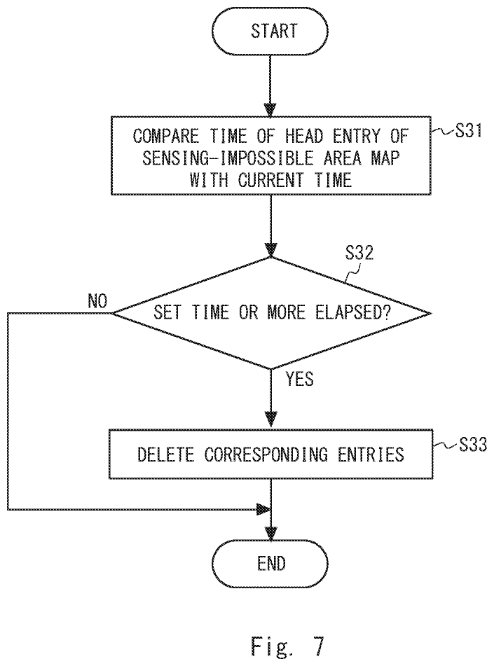

Next, the processing of updating the sensing-impossible area map 305 will be described with reference to FIG. 7. FIG. 7 is a flowchart showing the processing in the area management unit 301. Note that, in FIG. 7, each of the plurality of candidate area maps 3051 stored for the set time is an entry of the sensing-impossible area map 305.

First, the area management unit 301 compares the time of a first entry of the sensing-impossible area map 305 with the current time (S31). The first entry and the time thereof are the oldest entry and the corresponding emission time. The area management unit 301 determines from the result of comparison between the time of the first entry and the current time whether the set time or more has elapsed (S32).

If the set time or more has elapsed from the time of the first entry (YES in S32), the corresponding entries are deleted (S33), and the processing ends. If the set time or more has not elapsed from the time of the first entry (NO in S32), the area management unit 301 ends the processing without deleting any entry.

The above operation makes it possible to control the emission direction so as to satisfy a desired safety standard. When the set time or more has elapsed from the emission time of the emission in the emission-completed direction 305a, the output power of laser light per predetermined angle range satisfies the safety standard. Therefore, it is possible to emit the laser light around the emission-completed direction 305a. The area management unit 301 deletes old entries that have exceeded the set time.

In the foregoing description, in the case of the high-resolution mode, the area management unit 301 manages the emission-impossible direction. In other words, since the sensing density does not increase in the low-resolution mode, there is no risk that the safety standard is exceeded. Therefore, in the low-resolution mode, the control device 300 does not have to perform processing such as the management of the emission-impossible direction and the scheduling. It is needless to say that the management of the emission-impossible direction, and the like may be performed at any time. In other words, in both the low-resolution mode and the high-resolution mode, the area management unit 301 may perform the management of the emission-impossible direction and the scheduling.

CPU executes a program stored in ROM, for example, thereby implementing each component of the control device 300. Necessary programs may be recorded in any non-volatile recording medium and installed as needed. Note that each component is not limited to being implemented by software as described above, and may be implemented by hardware such as some kind of circuit element. Further, one or more of the above components may be respectively implemented by physically separate hardware pieces.

In the above example, the programs can be stored by using various types of non-transitory computer readable media and supplied to a computer. The non-transitory computer readable media include various types of tangible storage media. Examples of the non-transitory computer readable media include a magnetic recording medium (for example, flexible disk, magnetic tape, hard disk drive), magneto-optical recording medium (for example, magneto-optical disk), CD-ROM (Read Only Memory), CD-R, CD-R/W, a semiconductor memory (for example, mask ROM, PROM (Programmable ROM), EPROM (Erasable PROM), flash ROM, RAM (Random Access Memory)). Further, the programs may be supplied to the computer by various types of transitory computer readable media. Examples of the transitory computer-readable media include electrical signals, optical signals, and electromagnetic waves. The transitory computer readable media can supply the programs to the computer via a wired communication path such as an electric wire or an optical fiber, or a wireless communication path.

The invention of the present application has been described with reference to the example embodiments, but the invention of the present application is not limited to the foregoing. Various modifications can be made to the configuration and the details of the invention of the present application in styles which can be understood by a person skilled in the art within the scope of the invention.

Some or all of the foregoing example embodiments can be described in the following Supplementary notes, but are not limited to them.

(Supplementary Note 1)

A control device for a distance measurement sensor, comprising:

a first management unit configured to manage an emission-impossible direction of laser light according to output power per predetermined angular range of laser light to be swept by the distance measurement sensor;

a scheduler configured to schedule emission of the laser light based on the emission-impossible direction; and

an emission instruction unit configured to instruct an emission direction of the laser light according to the schedule.

(Supplementary Note 2)

The control device for a distance measurement sensor according to Supplementary note 1, wherein the first management unit manages a history of an emission-completed direction in which the laser light has been emitted, and an emission time, and calculates a sensing-impossible area containing the emission-impossible direction from the history.

(Supplementary Note 3)

The control device for a distance measurement sensor according to Supplementary note 1 or 2, further comprising a second management unit configured to manage a sensing request indicating a direction to be sensed, emission of laser light being instructed in a direction for which the sensing request is made and which is not the emission-impossible direction.

(Supplementary Note 4)

The control device for a distance measurement sensor according to any one of Supplementary notes 1 to 3, wherein

sensing is performed in a low-resolution mode before intrusion of an intruding object into a sensing area of the distance measurement sensor is detected,

the low-resolution mode is shifted to a high-resolution mode in which sensing is performed at a higher density in a direction to the intruding object as compared with the low-resolution mode when the intruding object has intruded into the sensing area of the distance measuring sensor, and

when the high-resolution mode has been set, the first management unit manages the emission-impossible direction of laser light.

(Supplementary Note 5)

A distance measurement sensor comprising:

an optical signal generation unit configured to generate an optical signal that is laser light;

a direction control unit configured to sweep the laser light so as to change an emission direction of the laser light;

a detector configured to detect reflected light from an object irradiated with the laser light;

a signal processing unit configured to process a detection signal from the detector to measure a distance to the object;

a first management unit configured to manage an emission-impossible direction of laser light according to output power of the swept laser light per predetermined angular range;

a scheduler configured to schedule emission of laser light based on the emission-impossible direction; and

an emission instruction unit configured to instruct an emission direction to the direction control unit according to the schedule.

(Supplementary Note 6)

The distance measurement sensor according to Supplementary note 5, wherein the first management unit manages a history of an emission-completed direction in which the laser light has been emitted, and an emission time, and calculates a sensing-impossible area containing the emission-impossible direction from the history.

(Supplementary Note 7)

The distance measurement sensor according to Supplementary note 5 or 6, further comprising a second management unit configured to manage a sensing request indicating a direction to be sensed, emission of laser light being instructed in a direction for which the sensing request is made and which is not the emission-impossible direction.

(Supplementary Note 8)

The distance measurement sensor according to any one of Supplementary notes 5 to 7, wherein

sensing is performed in a low-resolution mode before intrusion of an intruding object into a sensing area of the distance measurement sensor is detected,

the low-resolution mode is shifted to a high-resolution mode in which sensing is performed at a higher density in a direction to the intruding object as compared with the low-resolution mode when the intruding object has intruded into the sensing area of the distance measuring sensor, and

when the high-resolution mode has been set, the first management unit manages the emission-impossible direction of laser light.

(Supplementary Note 9)

A control method for a distance measurement sensor comprising:

a step of managing an emission-impossible direction of laser light according to output power of laser light to be swept by the distance measuring sensor per predetermined angular range;

a step of scheduling emission of laser light based on the emission-impossible direction; and

a step of instructing an emission direction of the laser light according to the schedule.

(Supplementary Note 10)

The control method for a distance measurement sensor according to Supplementary note 9, wherein

a history of an emission-completed direction in which the laser light has been emitted, and an emission time is managed, and

a sensing-impossible area containing the emission-impossible direction is calculated from the history.

(Supplementary Note 11)

The control method for a distance measurement sensor according to Supplementary note 9 or 10, further comprising a step of managing a sensing request indicating a direction to be sensed, emission of laser light being instructed in a direction for which the sensing request is made and which is not the emission-impossible direction.

(Supplementary Note 12)

The control method for a distance measurement sensor according to any one of Supplementary notes 9 to 11, wherein

sensing is performed in a low-resolution mode before intrusion of an intruding object into a sensing area of the distance measurement sensor is detected,

the low-resolution mode is shifted to a high-resolution mode in which sensing is performed at a higher density in a direction to the intruding object as compared with the low-resolution mode when the intruding object has intruded into the sensing area of the distance measuring sensor, and

when the high-resolution mode has been set, the emission-impossible direction of laser light is managed.

(Supplementary Note 13)

A non-transitory computer-readable medium configured to store a program for causing a computer to execute a control method for a distance measuring sensor that comprises:

a step of managing an emission-impossible direction of laser light according to output power of laser light to be swept by the distance measuring sensor per predetermined angular range;

a step of scheduling emission of laser light based on the emission-impossible direction; and

a step of controlling an emission direction of the laser light according to the schedule.

(Supplementary Note 14)

The non-transitory computer-readable medium according to Supplementary note 13, wherein a history of an emission-completed direction in which the laser light has been emitted, and an emission time is managed, and a sensing-impossible area containing the emission-impossible direction is calculated from the history.

(Supplementary Note 15)

The non-transitory computer-readable medium according to Supplementary note 13 or 14, wherein the control method further comprises a step of managing a sensing request indicating a direction to be sensed, emission of laser light being instructed in a direction for which the sensing request is made and which is not the emission-impossible direction.

(Supplementary Note 16)

The non-transitory computer-readable medium according to any one of Supplementary notes 13 to 15, wherein

sensing is performed in a low-resolution mode before intrusion of an intruding object into a sensing area of the distance measurement sensor is detected,

the low-resolution mode is shifted to a high-resolution mode in which sensing is performed at a higher density in a direction to the intruding object as compared with the low-resolution mode when the intruding object has intruded into the sensing area of the distance measuring sensor, and

when the high-resolution mode has been set, the emission-impossible direction of laser light is managed.

### REFERENCE SIGNS LIST

115 intruding object
201 distance measurement sensor
210 optical signal generation unit
211 collimation unit
213 direction control unit
215 light collection unit
216 detection unit
217 signal processing unit
218 communication unit
221 sensing area
300 control device
301 area management unit
302 sensing request management unit
303 scheduler
304 emission instruction unit
305 sensing-impossible area map
306 request bitmap

1. A control device for a distance measurement sensor, comprising:
a first management unit configured to manage an emission-impossible direction of laser light according to output power per predetermined angular range of laser light to be swept by the distance measurement sensor;
a scheduler configured to schedule emission of the laser light based on the emission-impossible direction; and
an emission instruction unit configured to instruct an emission direction of the laser light according to the schedule.

2. The control device for a distance measurement sensor according to claim 1, wherein the first management unit manages a history of an emission-completed direction in which the laser light has been emitted, and an emission time, and calculates a sensing-impossible area containing the emission-impossible direction from the history.

3. The control device for a distance measurement sensor according to claim 1, further comprising a second management unit configured to manage a sensing request indicating a direction to be sensed, emission of laser light being instructed in a direction for which the sensing request is made and which is not the emission-impossible direction.

4. The control device for a distance measurement sensor according to claim 1, wherein
sensing is performed in a low-resolution mode before intrusion of an intruding object into a sensing area of the distance measurement sensor is detected,
the low-resolution mode is shifted to a high-resolution mode in which sensing is performed at a higher density in a direction to the intruding object as compared with the low-resolution mode when the intruding object has intruded into the sensing area of the distance measuring sensor, and
when the high-resolution mode has been set, the first management unit manages the emission-impossible direction of laser light.

5. A distance measurement sensor comprising:
an optical signal generation unit configured to generate an optical signal that is laser light;
a direction control unit configured to sweep the laser light so as to change an emission direction of the laser light;
a detector configured to detect reflected light from an object irradiated with the laser light;
a signal processing unit configured to process a detection signal from the detector to measure a distance to the object;
a first management unit configured to manage an emission-impossible direction of laser light according to output power of the swept laser light per predetermined angular range;
a scheduler configured to schedule emission of laser light based on the emission-impossible direction; and
an emission instruction unit configured to instruct an emission direction to the direction control unit according to the schedule.

6. The distance measurement sensor according to claim 5, wherein the first management unit manages a history of an emission-completed direction in which the laser light has been emitted, and an emission time, and calculates a sensing-impossible area containing the emission-impossible direction from the history.

7. The distance measurement sensor according to claim 5, further comprising a second management unit configured to manage a sensing request indicating a direction to be sensed, emission of laser light being instructed in a direction for which the sensing request is made and which is not the emission-impossible direction.

8. The distance measurement sensor according to claim 5, wherein
sensing is performed in a low-resolution mode before intrusion of an intruding object into a sensing area of the distance measurement sensor is detected,
the low-resolution mode is shifted to a high-resolution mode in which sensing is performed at a higher density in a direction to the intruding object as compared with the low-resolution mode when the intruding object has intruded into the sensing area of the distance measuring sensor, and
when the high-resolution mode has been set, the first management unit manages the emission-impossible direction of laser light.

9. A control method for a distance measurement sensor comprising:
a step of managing an emission-impossible direction of laser light according to output power of laser light to be swept by the distance measuring sensor per predetermined angular range;
a step of scheduling emission of laser light based on the emission-impossible direction; and
a step of instructing an emission direction of the laser light according to the schedule.

10. The control method for a distance measurement sensor according to claim 9, wherein
a history of an emission-completed direction in which the laser light has been emitted, and an emission time is managed, and
a sensing-impossible area containing the emission-impossible direction is calculated from the history.

11. The control method for a distance measurement sensor according to claim 9, further comprising a step of managing a sensing request indicating a direction to be sensed, emission of laser light being instructed in a direction for which the sensing request is made and which is not the emission-impossible direction.

12. The control method for a distance measurement sensor according to claim 9, wherein
sensing is performed in a low-resolution mode before intrusion of an intruding object into a sensing area of the distance measurement sensor is detected,
the low-resolution mode is shifted to a high-resolution mode in which sensing is performed at a higher density in a direction to the intruding object as compared with the low-resolution mode when the intruding object has intruded into the sensing area of the distance measuring sensor, and
when the high-resolution mode has been set, the emission-impossible direction of laser light is managed.

13. A non-transitory computer-readable medium configured to store a program for causing a computer to execute a control method according to claim 9.

14. The non-transitory computer-readable medium according to claim 13, wherein a history of an emission-completed direction in which the laser light has been emitted, and an emission time is managed, and a sensing-impossible area containing the emission-impossible direction is calculated from the history.

15. The non-transitory computer-readable medium according to claim 13, wherein the control method further comprises a step of managing a sensing request indicating a direction to be sensed, emission of laser light being instructed in a direction for which the sensing request is made and which is not the emission-impossible direction.

16. The non-transitory computer-readable medium according to claim 13, wherein
sensing is performed in a low-resolution mode before intrusion of an intruding object into a sensing area of the distance measurement sensor is detected,
the low-resolution mode is shifted to a high-resolution mode in which sensing is performed at a higher density in a direction to the intruding object as compared with the low-resolution mode when the intruding object has intruded into the sensing area of the distance measuring sensor, and
when the high-resolution mode has been set, the emission-impossible direction of laser light is managed.
